(19) United States
(12) Patent Application Publication
(10) Pub. No.: US 2007/0227642 A1
(43) Pub. Date: Oct. 4, 2007

(54) Method of making multilayer electronic component

(75) Inventors: Tomohiko Komuro, Tokyo (JP); Kazuharu Takahashi, Nikaho-shi (JP); Hiroyuki Suzuki, Nikaho-shi (JP); Akitoshi Yoshii, Tokyo (JP); Kazuyuki Hasebe, Nikaho-shi (JP); Hiroshi Yagi, Nikaho-shi (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/723,308

(22) Filed: Mar. 19, 2007

(30) Foreign Application Priority Data
Mar. 29, 2006 (JP) 2006-091126

(51) Int. Cl. C03B 29/00

(52) U.S. Cl. 156/89.12; 156/89.16

(57) ABSTRACT

A method of making a multilayer electronic component which can further improve a withstand voltage characteristic is provided. In the method of making a multilayer capacitor in accordance with the present invention, a sheet multilayer body is formed in a multilayer body forming step by laminating a plurality of electrode sheets and blank sheets formed in a sheet forming step. The sheet multilayer body is fired in a firing step, whereby a multilayer capacitor is obtained. The sheet multilayer body includes one blank sheet interposed between the electrode sheets. Namely, two green sheets are interposed between electrode patterns of the electrode sheets, whereby the green sheet thickness is substantially increased. The inventors have newly found that increasing the green sheet thickness by making the sheet multilayer body have such a structure is effective in improving the withstand voltage characteristic.

### BACKGROUND OF THE INVENTION

1. Field of the Invention

The present invention relates to a method of making a multilayer electronic component produced by using a ceramic green sheet.

2. Related Background Art

A method of making a multilayer electronic component in this technical field has conventionally been disclosed in Japanese Patent Application Laid-Open No. 2005-72121, for example. The multilayer electronic component disclosed in this publication is produced by printing respective electrode patterns in predetermined regions arranged with a fixed pitch, cutting the regions into sheets thereafter, laminating a plurality of the sheets, and firing the green sheet into dielectric layers, so as to turn the electrode patterns into inner electrodes.

### SUMMARY OF THE INVENTION

Here, it has been known in general that a method of thickening dielectric layers is effective as a method of improving the withstand voltage characteristic of multilayer electronic components. Therefore, the above-mentioned conventional method of making a multilayer electronic component can improve the withstand voltage characteristic of its resulting multilayer electronic component to some extent by thickening the green sheet employed. The inventors have newly found a technique which further improves the withstand voltage characteristic as compared with multilayer electronic components which simply thicken dielectric layers as mentioned above.

Namely, it is an object of the present invention to provide a method of manufacturing a multilayer electronic component which can further improve the withstand voltage characteristic.

The method of making a multilayer electronic component in accordance with the present invention comprises a sheet forming step of forming a first sheet constituted by a dried green sheet, and a second sheet constituted by a dried green sheet and an electrode pattern provided thereon; a multilayer body forming step of laminating a plurality of the first and second sheets, so as to form a sheet multilayer body including the first sheet interposed between the second sheets; and a firing step of firing the sheet multilayer body.

In this method of making a multilayer electronic component, a sheet multilayer body is formed in the multilayer body forming step by laminating a plurality of first and second sheets formed in the sheet forming step. This sheet multilayer body is fired in the firing step, whereby the multilayer electronic component is obtained. Here, the sheet multilayer body is one in which a first sheet constituted by a dried green sheet is interposed between the second sheets each constituted by a dried green sheet and an electrode pattern provided thereon. Namely, at least two green sheets are interposed between the electrode patterns of the second sheets, which substantially increase the green sheet thickness. The inventors have newly found that increasing the green sheet thickness by making such a sheet multilayer body structure is more effective in improving the withstand voltage characteristic than simply increasing the green sheet thickness. That is, the method of making a multilayer electronic component in accordance with the present invention realizes a further improvement in the withstand voltage characteristic of the multilayer electronic component produced thereby.

The sheet forming step may form a sheet series including at least one first sheet positioned between the second sheets by cutting a long green sheet provided on a support, whereas the multilayer body forming step may form the sheet multilayer body by successively laminating the first and second sheets in the order of arrangement in the sheet series formed on the support. In this case, the first and second sheets cut from the long green sheet are transported by the same support and are successively laminated in the order of their arrangement, so that the multilayer body forming step becomes simpler in operation and shorter in time, whereby the multilayer electronic component is made more efficiently than in the case where the first and second sheets are transported separately from each other.

The sheet series provided on the support may have an equal pitch. In this case, the first and second sheets are arranged regularly, which simplifies the condition setting and programming in the multilayer body forming step.

The method may further comprise a sheet condition determining step of determining a thickness of the green sheet constituting the first and second sheets and a number of the first sheets positioned between the second sheets in the sheet multilayer body according to a desirable withstand voltage characteristic; the sheet forming step may form the first and second sheets by using the green sheet having the thickness determined in the sheet condition determining step; and the multilayer body forming step may form a sheet multilayer body interposing the first sheets between the second sheets by the number determined in the sheet condition determining step. In this case, appropriate sheet thickness and number are determined according to a desirable withstand voltage characteristic in the condition determining step, and thus determined sheet thickness and number are employed in later steps, whereby the multilayer electronic component having the desirable withstand voltage can be made efficiently.

### BRIEF DESCRIPTION OF THE DRAWINGS

FIG. 1 is a view showing a ceramic green sheet in accordance with an embodiment of the present invention, in which parts (a) and (b) are plan and sectional views, respectively;

FIG. 2 is a view showing the ceramic green sheet and electrode patterns in accordance with the embodiment of the present invention, in which parts (a) and (b) are plan and sectional views, respectively;

FIG. 3 is a view showing a sheet series in accordance with the embodiment of the present invention, in which parts (a) and (b) are plan and sectional views, respectively;

FIG. 4 is a view showing a multilayer body and sheet multilayer body in accordance with the embodiment of the present invention, in which parts (a) and (b) are respective sectional views of the multilayer body and sheet multilayer body;

FIG. 5 is a view showing a firing step in a method of making a multilayer capacitor in accordance with the embodiment;

FIG. 6 is a view showing a sheet series different from that of FIG. 3, in which parts (a) and (b) are plan and sectional views, respectively; and

FIG. 7 is a view showing a multilayer body and sheet multilayer body different from those of FIG. 4, in which parts (a) and (b) are respective sectional views of the multilayer body and sheet multilayer body.

### DESCRIPTION OF THE PREFERRED EMBODIMENTS

In the following, embodiments which seem to be the best when carrying out the present invention will be explained in detail with reference to the accompanying drawings. Constituents identical or equivalent to each other will be referred to with numerals identical to each other without repeating their overlapping explanations if any.

In the following embodiments, a multilayer capacitor will be explained as a multilayer electronic component by way of example.

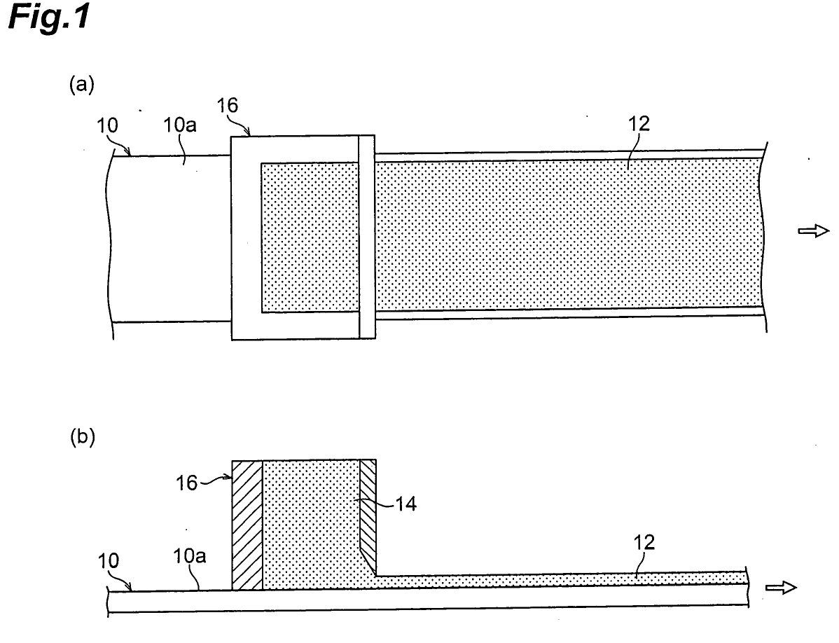

First, when making the multilayer capacitor in accordance with this embodiment, a green sheet is formed on a carrier film. Namely, as shown in FIG. 1, a ceramic green sheet 12 in an undried state is applied onto a main face 10a of a long carrier film (support) 10 transported by feed and windup rollers (not depicted). The ceramic green sheet 12 is constituted by a slurry 14 of ceramic powder and is formed by a doctor blading apparatus 16. Then, the ceramic green sheet 12 on the carrier film 10 is dried by a predetermined drying step, so as to form a green sheet 18 having a thickness of 34 μm. Thereafter, thus obtained green sheet 18 is once taken up by the windup roller together with the carrier film 10.

Before forming the green sheet 18, the thickness of the green sheet 18 and the number of sheets which will be explained later are determined according to a desirable withstand voltage characteristic as a sheet condition determining step. The following explanation assumes that the sheet thickness and number determined in the sheet condition determining step are 34 μm and 1, respectively.

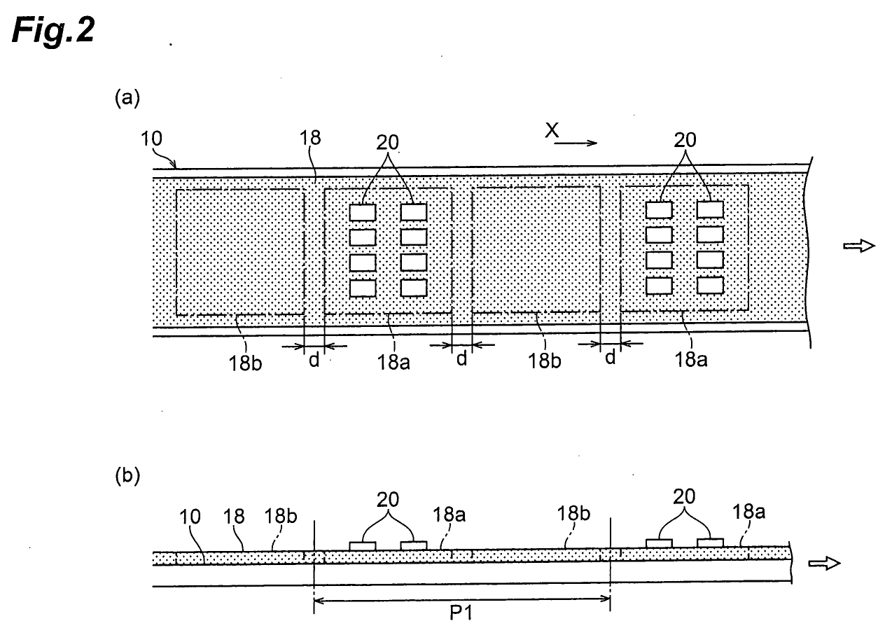

Subsequently, a predetermined electrode pattern is printed on thus formed green sheet 18. Namely, as shown in FIG. 2, an electrode pattern 20 is formed by screen printing only in a quadrangular electrode forming area 18a in the surface region of the green sheet 18 on the carrier film 10 transported by the feed and windup rollers (not depicted). This electrode pattern 20 becomes an inner electrode of the multilayer capacitor obtained by the manufacturing method in accordance with this embodiment, and is constituted by a conductor such as Cu or Ag, for example. The surface region of the green sheet 18 includes not only the above-mentioned electrode forming area 18a but also a blank area 18b having the same size and form as those of the electrode forming area 18a while being free of the electrode pattern 20. The electrode forming areas 18a and blank areas 18b are alternately arranged in the transporting direction of the green sheet 18 (depicted X direction). The adjacent electrode forming area 18a and blank area 18b align with each other while being separated by a fixed gap d from each other. Thus, pairs of electrode forming areas 18a and blank areas 18b are periodically arranged with a fixed pitch P1 in the green sheet 18.

For periodically forming the electrode forming areas 18a and blank areas 18b with the fixed pitch P1, (a) a method providing an alignment mark on the green sheet 18 and preliminarily feeding the sheet by the length of the blank area 18b with reference to the alignment mark, (b) a method of preliminarily feeding the green sheet 18 by regulating the transportation timing without using alignment marks, (c) a method of using a one-pitch pattern (i.e., a pattern corresponding to both of a pair of adjacent electrode forming area 18a and blank area 18b) as a screen pattern employed in screen printing, or the like can be utilized.

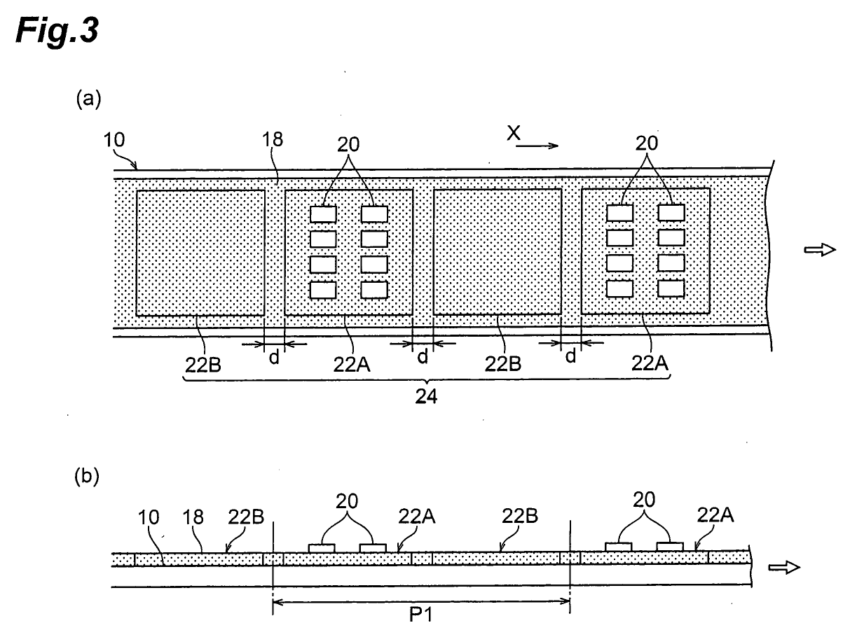

Next, as shown in FIG. 3, the green sheet 18 is cut along the outer edges of the above-mentioned electrode forming areas 18a and blank areas 18b (dash-single-dot lines in FIG. 2). Cutting means such as blade cutter or roller cutter can be used for the cutting. Consequently, electrode sheets (second sheets) 22A corresponding to the electrode forming areas 18a and blank sheets (first sheets) 22B corresponding to the blank areas 18b are cut from the green sheet 18.

As can be seen from the procedure explained in the foregoing, the electrode sheet 22A is constituted by the green sheet 18 and the electrode pattern 20 provided thereon, whereas the blank sheet 22B is constituted by the green sheet 18. The positional relationship between the electrode sheet 22A and blank sheet 22B is the same as the positional relationship between the above-mentioned electrode forming area 18a and blank area 18b as a matter of course. Namely, the electrode sheets 22A and blank sheets 22B are alternately arranged in the transporting direction of the green sheet 18 (depicted X direction), whereas the adjacent electrode sheet 22A and blank sheet 22B align with each other while being separated by a fixed gap d from each other, whereby a sheet series 24 in which pairs of electrode sheets 22A and blank sheets 22B are periodically arranged with an equal pitch P1 is formed on the carrier film 10.

The foregoing completes the sheet forming step.

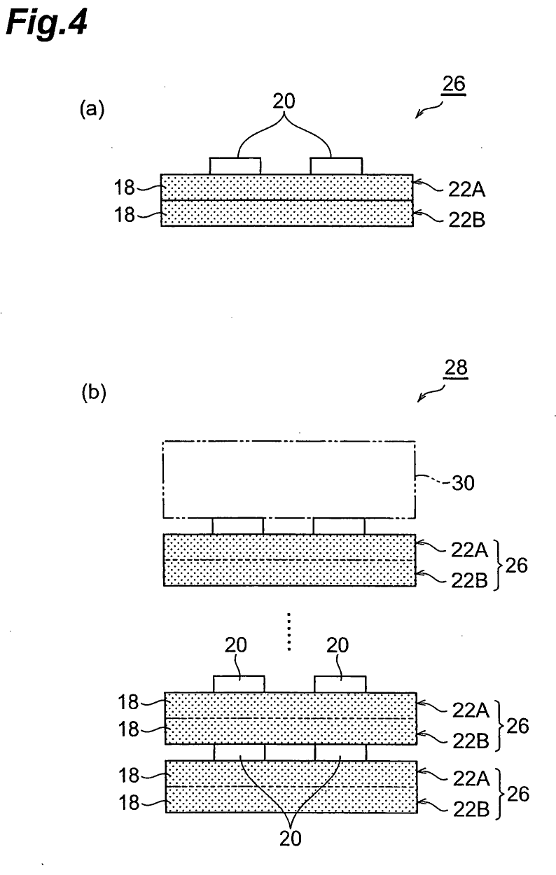

Next, the electrode sheets 22A and blank sheets 22B are laminated so as to form a sheet multilayer body. Specifically, the electrode sheets 22A and blank sheets 22B are successively laminated in the order of arrangement in the sheet series formed on the carrier film 10, so as to form a sheet multilayer body 28 shown in FIG. 4. Here, since the electrode sheets 22A and blank sheets 22B are arranged in the order of the blank sheet 22B and electrode sheet 22A along the transporting direction while constructing one pitch (P1) in the sheet series 24, a multilayer body 26 in which the electrode pattern 20 is formed on a two-tier green sheet 18 as shown in part (a) of FIG. 4 is obtained when the electrode sheet 22A and blank sheet 22B are peeled off by one pitch from the carrier film 10 and successively laminated.

Since a plurality of pairs (i.e., a plurality of pitches) of electrode sheets 22A and blank sheets 22B are formed on the carrier film 10, the sheet multilayer body 28 shown in part (b) of FIG. 4 is obtained when the electrode sheets 22A and blank sheets 22B are continuously laminated in succession in the order of arrangement in the sheet series 24. This sheet multilayer body 28 comprises a plurality of stages of the above-mentioned multilayer bodies 26 stacked therein and a cover sheet 30 constituted by the same material as that of the above-mentioned green sheet 18 overlaid thereon. In the sheet multilayer body 28, one blank sheet 22B is interposed between the electrode sheets 22A according to the sheet number (1) determined in the above-mentioned sheet condition determining step, whereas two green sheets 18 are interposed between the electrode patterns 20.

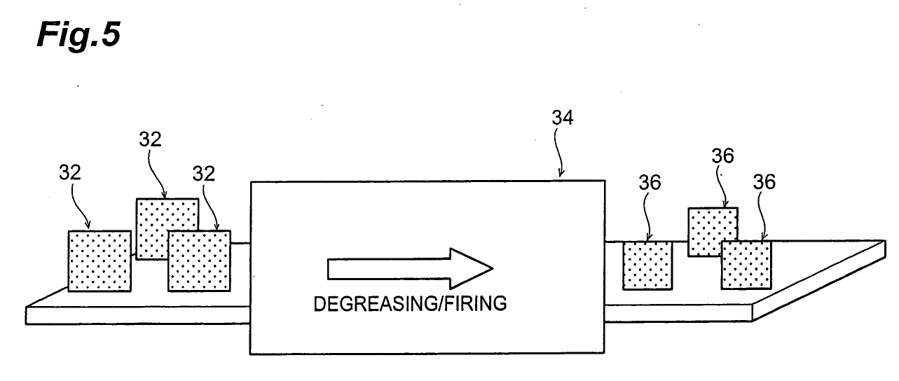

This sheet multilayer body 28 is cut into predetermined sizes, so as to yield multilayer body chips 32, which are thereafter subjected to degreasing and firing by a degreasing/firing apparatus 34 as shown in FIG. 5. Finally, thus obtained sintered bodies are formed with predetermined outer connecting terminals by a known method (e.g., paste coating and baking), which completes the making of multilayer capacitors 36.

As explained in the foregoing, a sheet multilayer body 28 in which the blank sheet 22B is interposed between the electrode sheets 22A is formed in the process of making the multilayer capacitors 36. Therefore, the green sheet thickness between the electrode patterns 20 is twice that of a sheet multilayer body made by using the electrode sheets 22A alone. The multilayer capacitor 36 realizes an improvement in withstand voltage characteristic by thus increasing the green sheet thickness.

The inventors have newly found that interposing two green sheets 18 between the electrode patterns 20 is more effective in improving the withstand voltage characteristic than simply using one green sheet having a double thickness. This seems to be because, while defects are easy to propagate in the thickness direction of a green sheet when one tier of green sheet is used, such defects are significantly inhibited from propagating at sheet boundaries when a plurality of green sheets are used. In addition, it seems that positions of defects inherent in the vertically stacked green sheets 18 are easy to deviate from each other, so that the possibility of defects being located at the same position is low, which is effective in improving the withstand voltage characteristic.

Though a method (so-called double coating) of further applying the slurry-like ceramic green sheet 12 onto the dried green sheet 18 so as to increase the green sheet thickness may be considered, a phenomenon (so-called sheet attack) in which a solvent in the ceramic green sheet 12 damages the green sheet 18 thereunder may occur in this case, thereby deteriorating the withstand voltage characteristic of the resulting multilayer capacitor. Since the dried green sheet 18 is used for constructing the electrode sheets 22A and blank sheets 22B in the above-mentioned embodiment, by contrast, no sheet attack is generated when they are stacked, whereby the withstand voltage characteristic is kept from deteriorating.

Further, in the above-mentioned embodiment, the electrode sheets 22A and blank sheets 22B cut from the long green sheet 18 are transported by the same carrier film 10, and are successively laminated in the order of their arrangement. Consequently, the operation of forming the sheet multilayer body 28 is simplified and shortened in terms of time as compared with the case where the electrode sheets 22A and blank sheets 22B are transported separately from each other. Therefore, the multilayer capacitors 36 can be made efficiently.

In addition, since the sheet series 24 provided on the carrier film 10 has an equal pitch (i.e., the sheets are regularly arranged while being separated from each other by the same gap d), various kinds of condition setting and programming of the apparatus for laminating the multilayer capacitors 36 are simplified.

Also, in the above-mentioned embodiment, the thickness of the green sheet 18 and the number of blank sheets 22B positioned between the electrode sheets 22A in the sheet multilayer body 28 (hereinafter referred to as interposed sheet number) are set to optimal values (sheet thickness: 34 μm; interposed sheet number: 1) according to the desirable withstand voltage characteristic of the multilayer capacitor 36 as the sheet condition determining step. This keeps the thickness of the green sheet 18 and the interposed sheet number in the sheet multilayer body 28 from unnecessarily increasing in order to attain the desirable withstand voltage characteristic, so that the multilayer capacitor 36 having a desirable withstand voltage characteristic can efficiently be made while lowering its manufacturing cost.

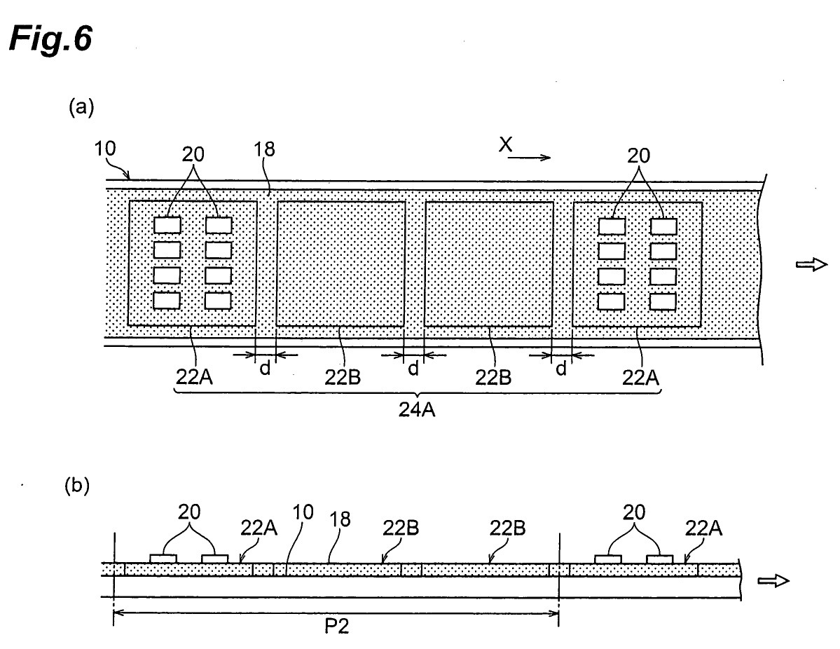

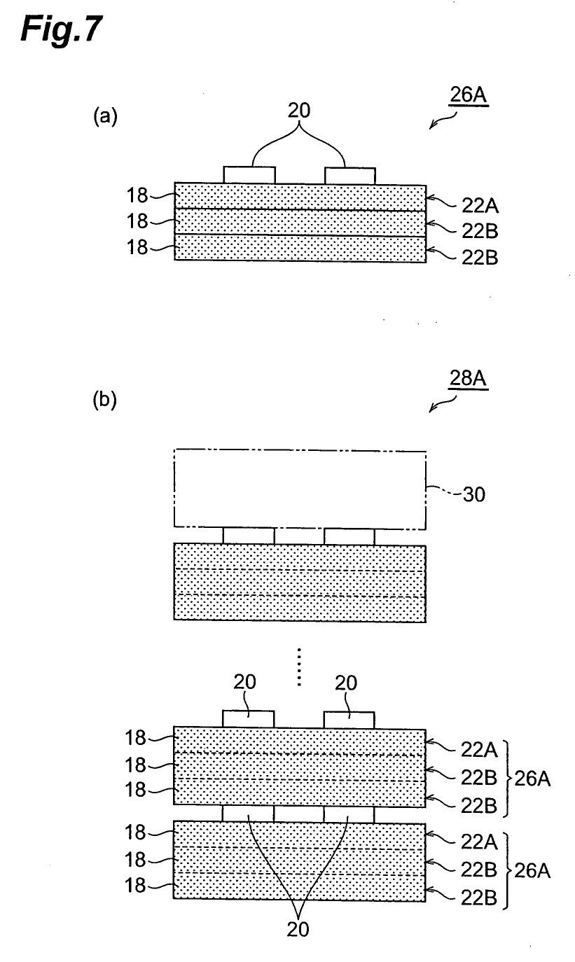

The interposed sheet number of the sheet multilayer body 28 (the number of blank sheets 22B interposed between the electrode sheets 22A) can easily be altered in the following manner. How to change the interposed sheet number to 2 will now be explained with reference to FIGS. 6 and 7. Namely, the following embodiment is one in which the interposed sheet number of the sheet multilayer body 28 is set to 2 in the sheet condition determining step according to a desirable withstand voltage characteristic.

As in the above-mentioned manufacturing method, a predetermined electrode pattern is printed on a green sheet 18, and the green sheet 18 is cut along the outer edges of electrode forming areas 18a and blank areas 18b as the sheet forming step in this embodiment. Consequently, a sheet series 24A shown in FIG. 6 is formed on the carrier film 10. In this sheet series 24A, one electrode sheet 22A and two blank sheets 22B are lined up in the order of the blank sheets 22B and electrode sheet 22A, whereby sheet groups each composed of three sheets are periodically arranged with an equal pitch P2.

Then, a sheet multilayer body 28A is formed by the same procedure as that of the above-mentioned manufacturing method. Specifically, the electrode sheets 22A and blank sheets 22B are successively laminated in the order of arrangement in the sheet series 24A, so as to form the sheet multilayer body 28A shown in FIG. 7.

Since the electrode sheet 22A and blank sheets 22B are arranged in the order of the blank sheets 22B and electrode sheet 22A along the transporting direction so as to construct one pitch (P1), a multilayer body 26A in which an electrode pattern 20 is formed on a three-tier green sheet 18 as shown in part (a) of FIG. 7 is obtained when the electrode sheet 22A and blank sheets 22B are peeled off by one pitch from the carrier film 10 and successively laminated.

Since a plurality of groups (e.g., a plurality of pitches) of electrode sheets 22A and blank sheets 22B are formed on the carrier film 10, the sheet multilayer body 28A shown in part (b) of FIG. 7 is obtained when the electrode sheets 22A and blank sheets 22B are continuously laminated in succession in the order of arrangement in the sheet series 24A. This sheet multilayer body 28A comprises a plurality of stages of the above-mentioned multilayer bodies 26A stacked therein and a cover sheet 30 overlaid thereon. In the sheet multilayer body 28A, two blank sheets 22B are interposed between the electrode sheets 22A according to the sheet number (2) determined in the above-mentioned sheet condition determining step, while three green sheets 18 are interposed between the electrode patterns 20.

Namely, changing the arrangement of electrode sheets 22A and blank sheets 22B in the sheet series 24, 24A provided on the carrier film 10 can easily increase and decrease the interposed sheet number of the sheet multilayer body 28. The interposed sheet number is changed as necessary.

### EXAMPLES

Examples will now be explained in order to further clarify effects of the present invention.

For elucidating the relationship between the withstand voltage characteristic of the multilayer capacitor and the interposed sheet number of the sheet multilayer body, the inventors prepared 100 each of three kinds of multilayer capacitors with different interposed sheet numbers (0, 1, 2) and performed a withstand voltage test at 100 V. The results were as shown in the following Table 1.

TABLE 1

| | WITHSTAND | | |
|---|---|---|---|
| | VOLTAGE (V) | | |
| | 100 | 100 | 100 |
| INTERPOSED SHEET | 0 | 1 | 2 |
| NUMBER | | | |
| FAILURE RATE | 47/100 | 21/100 | 0/100 |

As can be seen from Table 1, the failure rate becomes lower (i.e., the withstand voltage characteristic becomes higher) as the interposed sheet number increases. Therefore, for simply improving the withstand voltage characteristic, it will be preferred if the multilayer capacitor is made by using a sheet multilayer body with a greater interposed sheet number.

However, this increases the interposed sheet number unnecessarily. Therefore, from the viewpoints of manufacturing time and cost, it will be preferred if the minimum interposed sheet number that can realize a desirable withstand voltage characteristic is employed.

Hence, for determining an appropriate interposed sheet number, the inventors conducted a comparative test between a case using a green sheet made of material A and a case using a green sheet made of material B. In this comparative test, the minimum interposed sheet number yielding no failure in the solid electrolytic capacitor (a failure rate of 0) was investigated at each withstand voltage. The results were as shown in the following Table 2.

TABLE 2

| | WITHSTAND VOLTAGE (V) | | | | |
|---|---|---|---|---|---|
| | 100 | 200 | 300 | 400 | 500 |
| REQUIRED SHEET NUMBER | 1 | 1 | 2 | 2 | 2 |
| IN MATERIAL A | | | | | |
| REQUIRED SHEET NUMBER | 0 | 0 | 1 | 1 | 2 |
| IN MATERIAL B | | | | | |

As can be seen from Table 2, the interposed sheet number required for yielding no failure when using the green sheet made of material A is 1 (at a withstand voltage of 100 V), 1 (at a withstand voltage of 200 V), 2 (at a withstand voltage of 300 V), 2 (at a withstand voltage of 400 V), and 2 (at a withstand voltage of 500 V). On the other hand, the interposed sheet number required for yielding no failure when using the green sheet made of material B is 0 (at the withstand voltage of 100 V), 0 (at the withstand voltage of 200 V), 1 (at the withstand voltage of 300 V), 1 (at the withstand voltage of 400 V), and 2 (at the withstand voltage of 500 V).

These results indicate that, in the case where a solid electrolytic capacitor having a withstand voltage characteristic of 100 to 400 V is needed, for example, employing a green sheet made of material B shortens the laminating time when forming a sheet multilayer body and improves the yield. In the case where a solid electrolytic capacitor having a withstand voltage characteristic of 500 V is necessary, for example, both of the respective green sheets made of materials A and B require an interposed sheet number of 2, whereby it will be sufficient if one of materials A and B is chosen from the viewpoints of cost, availability, and the like.

Without being restricted to the above-mentioned embodiments, the present invention can be modified in various ways. For example, the multilayer electronic component is not limited to the multilayer capacitor, but may be various electronic components such as piezoelectric chip components and chip varistor components of multilayer type.

The present invention provides a method of making a multilayer electronic component which can further improve the withstand voltage characteristic.

What is claimed is:

1. A method of making a multilayer electronic component, the method comprising:
a sheet forming step of forming a first sheet constituted by a dried green sheet, and a second sheet constituted by a dried green sheet and an electrode pattern provided thereon;
a multilayer body forming step of laminating a plurality of the first and second sheets, so as to form a sheet multilayer body including the first sheet interposed between the second sheets; and
a firing step of firing the sheet multilayer body.

2. A method of making a multilayer electronic component according to claim 1, wherein the sheet forming step forms a sheet series including at least one first sheet positioned between the second sheets by cutting a long green sheet provided on a support; and
wherein the multilayer body forming step forms the sheet multilayer body by successively laminating the first and second sheets in the order of arrangement in the sheet series formed on the support.

3. A method of making a multilayer electronic component according to claim 2, wherein the sheet series provided on the support has an equal pitch.

4. A method of making a multilayer electronic component according to claim 1, further comprising a sheet condition determining step of determining a thickness of the green sheet constituting the first and second sheets and a number of the first sheets positioned between the second sheets in the sheet multilayer body according to a desirable withstand voltage characteristic;
wherein the sheet forming step forms the first and second sheets by using the green sheet having the thickness determined in the sheet condition determining step; and
wherein the multilayer body forming step forms a sheet multilayer body interposing the first sheets between the second sheets by the number determined in the sheet condition determining step.
